(19) United States
(12) Patent Application Publication
(10) Pub. No.: US 2025/0350494 A1
(43) Pub. Date: Nov. 13, 2025

(54) EXPOSING INTERFACES ON CUSTOMER PREMISES NETWORKS FOR USE BY CLOUD-EXECUTED EDGE APPLICATIONS

(71) Applicant: Amazon Technologies, Inc., Seattle, WA (US)

(72) Inventors: QingYun Wei, San Jose, CA (US); Avinash Joshi, San Jose, CA (US); Xi Chen, Belmont, CA (US); MohammadHossein Zoualfaghari, Woodbridge (GB); Ajay Bhimrao Rane, Irvine, CA (US); Robin Satish Harwani, Frisco, TX (US)

(21) Appl. No.: 18/759,668

(22) Filed: Jun. 28, 2024

Related U.S. Application Data
(60) Provisional application No. 63/643,730, filed on May 7, 2024.

(51) Int. Cl. H04L 12/46; H04L 12/66; H04L 61/5014; H04L 101/618

(52) U.S. Cl. CPC H04L 12/4641; H04L 12/66; H04L 61/5014; H04L 2101/618

(57) ABSTRACT

Disclosed are various embodiments that expose interfaces on customer premises networks for use by cloud-executed edge applications. In one embodiment, a layer-3 virtual private network is established between a cloud provider network and a customer premises network of a customer. A layer-2 virtual interface is established for an edge application executed on the cloud provider network using a tunnel to encapsulate layer-2 traffic over the layer-3 virtual private network. An interface on an edge device of the customer premises network is mapped so that the interface is accessible by the edge application via the tunnel.

### CROSS-REFERENCE TO RELATED APPLICATIONS

This application claims priority to, and the benefit of, U.S. Provisional Patent Application No. 63/643,730, entitled “EXTENDING CUSTOMER PREMISES NETWORKS ONTO A CLOUD PROVIDER NETWORK,” and filed on May 7, 2024, which is incorporated herein by reference in its entirety.

### BACKGROUND

In recent years, the proliferation of Internet of Things (IoT) devices has significantly transformed the way we interact with and manage our surroundings. IoT devices may be characterized by their ability to collect, process, and exchange data with other devices and systems over the internet. These devices have found applications in diverse sectors, including healthcare, agriculture, transportation, smart homes, industrial automation, and more. The concept of IoT revolves around the interconnection of everyday objects and systems, enabling them to communicate and collaborate. These devices may be designed to monitor and interact with their environment autonomously, enabling data-driven decision-making, real-time control, and enhanced efficiency in various domains. IoT devices encompass a wide range of form factors and functionalities, from small, low-power sensors to complex, high-performance devices. These devices can be found in various settings, including smart thermostats, wearable fitness trackers, autonomous vehicles, industrial robots, and smart city infrastructure.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates one example of a networked environment corresponding to a deployment of the extension of customer premises networks onto cloud provider networks according to various embodiments of the present disclosure.

FIG. 2A is a schematic block diagram of a networked environment according to various embodiments of the present disclosure.

FIG. 2B is a schematic block diagram of a networked environment corresponding to a variation of the networked environment of FIG. 2A to support cloud-based large language models (LLMs) according to various embodiments of the present disclosure.

FIG. 3 is a sequence diagram showing how edge devices work with a virtual private network server and a container manager to launch a container with an edge application and establish the related tunnels according to various embodiments of the present disclosure.

FIG. 4A illustrates one example of a format employed for internet protocol (IP) version 6 network addressing by a virtual private network server according to various embodiments of the present disclosure.

FIG. 4B is a schematic block diagram of a networked environment with multiple edge devices on a customer premises network extended to the cloud provider network according to various embodiments of the present disclosure.

FIG. 5 is a schematic block diagram of a networked environment illustrating one example implementation of an on-device agent or software development kit (SDK) in an edge device according to various embodiments of the present disclosure.

FIG. 6A is a schematic block diagram of a networked environment illustrating hardware resource mappings according to various embodiments of the present disclosure.

FIG. 6B a drawing of a networked environment that uses the cloud provider network to link or connect multiple customer premises networks according to various embodiments of the present disclosure.

FIG. 7A is a schematic block diagram of a networked environment illustrating the use of native virtual private network servers in edge devices according to various embodiments of the present disclosure.

FIG. 7B is a schematic block diagram of a networked environment illustrating the use of native external access virtual private network servers as cloud container applications according to various embodiments of the present disclosure.

FIGS. 8A and 8B are flowcharts illustrating one example of functionality implemented as portions of the networked environments of FIGS. 2A and 2B according to various embodiments of the present disclosure.

FIG. 9 is a schematic block diagram that provides one example illustration of a computing device used as an edge device according to various embodiments of the present disclosure.

### DETAILED DESCRIPTION

The present disclosure generally relates to extending a customer premises network, such as a home network or office network, onto a cloud provider network so that applications executing on the cloud provider network can appear to be directly on the customer premises network and have access to hardware interfaces of the customer premises network. Customer premises networks are typically walled off from the Internet by a router acting as a network address translation (NAT) gateway. The router may be configured to automatically assign private network addresses to devices on the customer premises networks using the dynamic host configuration protocol (DHCP). These private network addresses are non-routable on the Internet, which means that Internet-connected devices cannot initiate communication to the devices on the customer premises network without manual configuration and techniques such as port forwarding, although the devices on the customer-premises network are able to initiate communication with the Internet-connected devices.

There may be a desire to run applications on devices connected to customer premises networks, for example, to manage IoT devices. Such IoT devices can include smart televisions, smart speakers, voice interface devices, smart doorbells, security cameras, remote controls, thermostats, appliances, light bulbs, lighting fixtures, electrical switches, electrical receptacles, environmental sensors, and so forth. However, customer premises equipment (CPE) that are desired to run applications may have limited computing resources. Examples of CPE may include television set-top boxes, smart televisions, Internet router/gateways, and so on. In some cases, the CPE may be provided to the customer by a communication service provider (CSP), and there may be a need to keep the hardware cost as low as possible.

Various embodiments of the present disclosure employ edge CPE devices as a gateway to a cloud provider network, where the customer premises network is extended via tunneling onto the cloud provider network, such that applications can be launched on the cloud provider network and appear as if they were directly connected to the customer premises network. These applications may include a wide range of container or virtual machine-based cloud applications for smart home, video surveillance, file storage, home security, and other usages, which could not be provided from the limited computing resources of the edge CPE devices.

Moreover, in some embodiments, the cloud applications may be able to directly access device, network, and radio interfaces such as RS-232 serial ports, universal serial bus (USB) ports, Z-WAVE interfaces, ZIGBEE interfaces, BLUETOOTH low energy interfaces, LORAWAN interfaces, and so forth. Protocols that are not normally routable from the consumer premises network to the Internet may also be available to the applications, such as multicast domain name system (mDNS), universal plug and play (UPnP), digital living network alliance (DLNA), SAMBA, MATTER, THREAD, HOMEKIT, ONVIF, MQTT, and so on. Some of these cloud applications may be headless, or having no user interface, while others may generate a user interface and encode the user interface for rendering by a CPE device.

In some embodiments, secure remote access may be provided so that mobile devices or other remote devices can connect to the customer premises network. Through this remote connection, the mobile devices or other remote devices are able to access the cloud applications on the extension of the customer premises network as if the mobile device or other remote devices were locally connected to the customer premises network.

In some embodiments, a large language model (LLM) such as a micro-LLM or a micro language model may be hosted in a cloud provider network in order to enhance devices on a customer premises network. Micro-LLMs may serve as the core foundation of various AI applications. These precision-tuned language models are designed to deliver exceptional accuracy, cost-efficiency, and speed, particularly in application development scenarios. Rather than entering a never-ending arms race for bigger models, businesses are embracing micro-LLMs as smaller, specialized language models tailored to meet the precise needs of enterprises across industries, domains, and individual customers. These fine-tuned micro LLMs provide a practical way to leverage AI while avoiding the pitfalls of massive, unfocused models. By narrowing the scope, micro-LLMs can deliver insights tailored to specific requirements, enhancing the effectiveness and efficiency of business operations.

For example, in a smart home environment, micro-LLMs can be highly useful for enhancing voice-activated devices like smart speakers or home automation systems. For example, a micro-LLM could be used by a smart speaker to manage and respond to everyday queries and commands more efficiently. This could include controlling home lighting, adjusting the thermostat, managing security systems, or providing real-time responses to questions about weather or news, all while requiring less processing power and offering faster response times. This integration not only improves user interaction through natural language processing but also enhances the functionality of the smart home ecosystem, making it more intuitive and responsive to the homeowner's needs.

As one skilled in the art will appreciate in light of this disclosure, certain embodiments may be capable of achieving certain advantages, including some or all of the following: (1) improving the functioning of CPE devices that have limited compute or storage resources by off-loading computing and storage tasks to applications executed in a cloud provider network; (2) reducing complexity of edge CPE devices without reducing functionality, thereby reducing power consumption and cost; (3) enabling seamless upgrading of edge applications on customer premises networks; (4) enabling cloud-executed application to access hardware interfaces on a customer premises network as if they were directly connected to the customer premises networks, thereby enabling wired and wireless connectivity with additional CPE devices; (5) facilitating remote access to cloud-executed applications on a customer premises network; (6) enhancing the capabilities of edge CPE devices with cloud-hosted LLMs; (7) improving security and privacy for customer premises networks by avoiding exposing application programming interfaces (APIs) for controlling on-premises devices to the open Internet; and so forth.

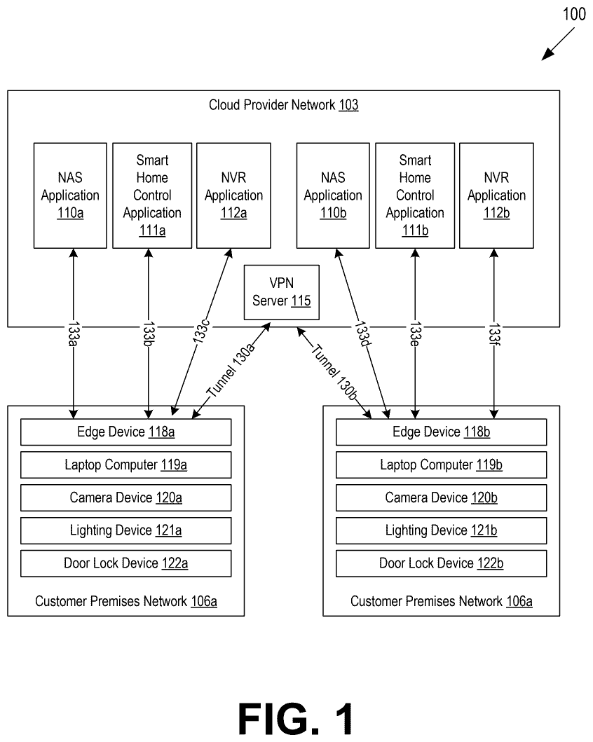

FIG. 1 illustrates one example of a networked environment 100 corresponding to a deployment of the extension of customer premises networks onto cloud provider networks. In this example, a cloud provider network 103 extends a plurality of customer premises networks 106a, 106b. For example, the customer premises network 106a may correspond to a first user, while the customer premises network 106b may correspond to a second user. The cloud provider network 103 includes several edge applications launched for the users: a network attached storage (NAS) application 110a, 110b; a smart home control application 111a, 111b; and a network video recorder (NVR) application 112a, 112b. A virtual private network (VPN) server 115 is also present on the cloud provider network 103 to provide connectivity between the edge applications and the respective customer premises networks 106a, 106b.

A number of devices may be connected to each respective customer premises network 106. In this non-limiting example for illustrative purposes only, each customer premises network 106 has a respective edge device 118a, 118b to serve as a gateway; a laptop computer 119a, 119b; a camera device 120a, 120b; a lighting device 121a, 121b; and a door lock device 122a, 122b. For example, the camera devices 120 may upload video streams to the respective NVR applications 112, the lighting devices 121 and door lock devices 122 may be controlled by the respective smart home control applications 111, and the laptop computers 119 may access data stored by the respective NAS application 110.

In order to allow the edge applications on the cloud provider network 103 obtain the local internet protocol (IP) addresses from the corresponding customer premises network 106, a tunnel-over-tunnel approach and reverse VPN tunneling is employed. The edge device 118 executes an IP tunnel server to provide the customer premises network 106 addressing and access to cloud applications that are running as IP-tunnel clients. Such tunneling may support layer-2 Ethernet over IP encapsulation, since multicast protocol support like multicast domain name system (mDNS) may be used over the tunnel. A VPN server 115 such as WIREGUARD, OPENVPN, or IPSEC is employed to establish the layer-3 IPv6 connectivity between edge device 118 and a machine instance on the cloud provider network 103 first.

Then over the internal IPv6 network, a container for the application further creates a virtual layer-2 Ethernet interface using an IPv6 Generic Routing Encapsulation Terminal Access Point (GRE-TAP) tunnel or an Ethernet over IP tunnel with the edge device 118. After that, the edge device 118 enables bridging between its physical local Wi-Fi or Ethernet network and the GRE-TAP tunnel interface to provide the IPv4 or IPv6 addressing from home network and local area network (LAN) access or Internet access for the edge application in the cloud provider network 103.

The respective edge device 118 that functions as a gateway connects to the VPN server 115 by way of a respective tunnel 130a, 130b that provides IPv6 layer-3 network connectivity. Over this tunnel 130, the applications on the cloud provider network 103 establish respective tunnels 133a-133f with the respective edge device 118 to bridge layer-2 or Ethernet network traffic.

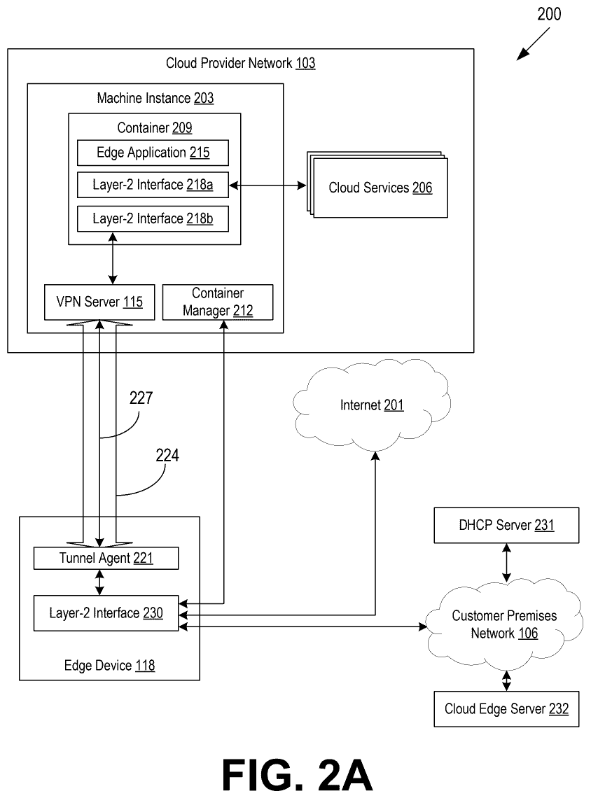

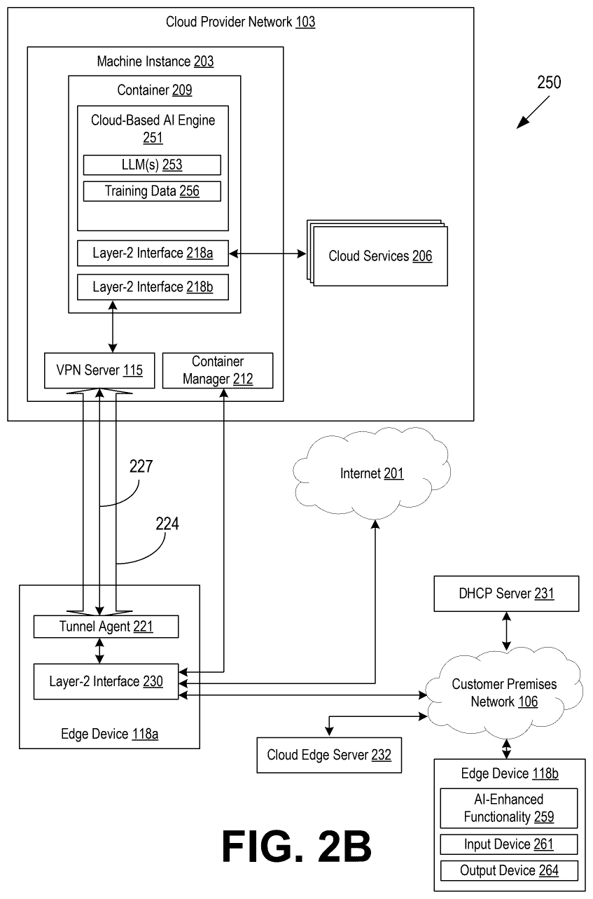

With reference to FIG. 2A, shown is a networked environment 200 according to various embodiments. The networked environment 200 includes a cloud provider network 103 in data communication with an edge device 118, which is in turn in data communication with the Internet 201 and/or the customer premises network 106.

The cloud provider network 103 (sometimes referred to simply as a “cloud”), is a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable loads. Cloud computing can thus be considered as both the applications delivered as services over a publicly accessible network (e.g., the Internet, a cellular communication network) and the hardware and software in cloud provider data centers that provide those services.

A cloud provider network 103 can be formed as a number of regions, where a region is a separate geographical area in which the cloud provider clusters data centers. Example regions include U.S. East (located on the east coast of the U.S.), U.S. West (located on the west coast of the U.S.), Europe—London, and Europe—Paris. Each region can include two or more availability zones connected to one another via a private high-speed network, for example a fiber communication connection. An availability zone refers to an isolated failure domain including one or more data center facilities with separate power, separate networking, and separate cooling from those in another availability zone. Preferably, availability zones within a region are positioned far enough away from one other that the same natural disaster should not take more than one availability zone offline at the same time. Customers can connect to availability zones of the cloud provider network 103 via a publicly accessible network (e.g., the Internet, a cellular communication network) to access resources and services of the cloud provider network. Transit Centers (TCs) are the primary backbone locations linking customers to the networked environment 200, and may be co-located at other network provider facilities (e.g., Internet service providers, telecommunications providers). Each region can operate two TCs for redundancy. The cloud provider network 103 may deliver content from points of presence outside of, but networked with, these regions by way of edge locations and regional edge cache servers (points of presence, or PoPs). This compartmentalization and geographic distribution of computing hardware enables the cloud provider network to provide low-latency resource access to customers on a global scale with a high degree of fault tolerance and stability.

Generally, the traffic and operations of a cloud provider network may broadly be subdivided into two categories: control plane operations carried over a logical control plane and data plane operations carried over a logical data plane. While the data plane represents the movement of user data through the networked environment 200, the control plane represents the movement of control signals through the networked environment 200. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the provider network (e.g., computing instances, containers, block storage volumes, databases, file storage). Data plane traffic generally includes non-administrative operations such as transferring customer data to and from the customer resources. The control plane components are typically implemented on a separate set of servers from the data plane servers, and control plane traffic and data plane traffic may be sent over separate/distinct networks.

The cloud provider network 103 may execute one or more machine instances 203 and one or more cloud services 206. The machine instances 203 may comprise bare-metal machine instances or virtual machine instances. The cloud services 206 may include various types of services accessible to customers of the cloud provider network 103, including block storage services, key-value storage services, serverless compute services, IoT device management services, machine learning or artificial intelligence services, and so on.

Executed on the machine instance 203 may be one or more containers 209, a VPN server 115, a container manager 212, and/or other components. In some cases, the machine instances 203 may correspond to a generic container execution environment that does not expose resources of the machine instance 203 to the customer.

A container 209, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers 209 at runtime. Containers 209 are thus an abstraction of the application layer (meaning that each container simulates a different software application process). Though each container 209 runs isolated processes, multiple containers 209 can share a common operating system, for example by being launched within the same virtual machine. In contrast, virtual machines are an abstraction of the hardware layer (meaning that each virtual machine simulates a physical machine that can run software). Virtual machine technology can use one physical server to run the equivalent of many servers (each of which is called a virtual machine). While multiple virtual machines can run on one physical machine, each virtual machine typically has its own copy of an operating system, as well as the applications and their related files, libraries, and dependencies. Virtual machines are commonly referred to as compute instances or simply “instances.” Some containers 209 can be run on instances that are running a container agent, and some containers 209 can be run on bare-metal servers.

The container 209 may incorporate a container runtime, such as containerd, CRI-O, DOCKER, and so on. The container runtime may meet a Runtime Specification of the Open Container Initiative. The container manager 212 is executed to manage the lifecycle of container 209, including provisioning, deployment, scaling up, scaling down, networking, load balancing, and other functions. Non-limiting examples of commercially available container managers 212 include KUBERNETES, APACHE MESOS, DOCKER orchestration tools, and so on.

The container 209 includes an edge application 215, a layer-2 interface 218a, and a layer-2 interface 218b. The edge application 215 may be any application desired to be executed on a customer premises network 106, include the non-limiting examples of the NAS application 110, the smart home control application 111, the NVR application 112, and other applications. The layer-2 interface 218a may be on a virtual private cloud network or other subnetwork of the cloud provider network 103, which enables the layer-2 interface 218a to access resources such as the cloud services 206. The layer-2 interface 218b may correspond to a tunnel endpoint for the VPN server 115 to expose the layer-2 traffic bridged from the customer premises network 106 by the VPN server 115. The layer-2 interface 218b may be connected to the VPN server 115 using media access control virtual local area network (MacVLAN) or another approach. In some examples, a container may have layer-2 interfaces 218b to multiple customer premises networks 106, thereby allowing the edge application 215 to perform functionality for the multiple networks 106, including the ability to bridge or route traffic from one network 106 to another network 106.

The VPN server 115 is connected to a tunnel agent 221 on the edge device 118 by way of a layer-3 tunnel 224 (e.g., WIREGUARD), and a layer-2 tunnel 227 (e.g., GRE-TAP) that runs within the layer-3 tunnel 224. The tunnel agent 221 forwards or bridges the layer-2 traffic to and from a layer-2 interface 230. The layer-2 interface 230 may be connected to the customer premises network 106, the Internet 201, and the container manager 212 (e.g., for controlling the operation of the containers 209), where transport layer security (TLS) may be used to encrypt the traffic between the layer-2 interface 230 and the container manager 212. The TLS traffic may traverse the Internet 201 between the edge device 118 and the cloud provider network 103.

The endpoint of the layer-3 tunnel 224 on the tunnel agent 221 may be provisioned with an IPv6 (or IPv4) address that enables the tunnel agent 221 to join a virtual private cloud network on the cloud provider network 103 that allows the tunnel agent 221 to communicate with the containers 209. The containers 209 can communicate with the tunnel agent 221 using their IPv6 (or IPv4) addresses through the layer-3 tunnel 224 in order to establish the inner layer-2 tunnel 227.

The tunnel agent 221 may create virtual IPv4 (or IPv6) addresses for the containers 209 by obtaining local addresses from a dynamic host configuration protocol (DHCP) server 231 on the customer premises network 106. For example, the tunnel agent 221 may send or forward DHCP broadcast requests to the customer premises network 106, which are then received by the DHCP server 231 on the customer premises network 106. IPv6 addresses, IPv4 addresses, routing configuration, and key credentials for both the layer-3 tunnel 224 and the layer-3 tunnel 227 may be passed between the edge device 118 and the VPN server 115 through a hypertext transfer protocol secure (HTTPS) signaling channel or other encrypted signaling channel.

Over the inner layer-2 tunnel 227, the container 209 can obtain access to the Internet 201 and the customer premises network 106 using local network addressing. All of the packet forwarding among WIREGUARD, GRE-TAP, and Ethernet interfaces for tunneling, encryption/decryption, and bridging may be conducted in Linux kernel mode, which improves the performance and reduce latency.

On the cloud side, the VPN server 115 may implement the WIREGUARD management plane to maintain WIREGUARD per-device keys and assign IPv6 addresses for the connected edge devices 118. When the container manager 212 launches a new container 209 to run an edge application 215, the original container-to-cloud virtual network interface, the layer-2 interface 218a, may be renamed as “eth1”. The “eth1” is assigned with an IPv4 address to allow the container to communicate with other cloud services 206.

The VPN server 115 may establish a layer-2 tunnel 227 (interface “grX”) through the layer-3 tunnel 224 with edge devices 118 for the container 209. Then container manager 212 can create the MacVLAN based “eth0” interface, the layer-2 interface 218b, inside the container with parent interface “grX” on the host side. The IP address provided by the tunnel agent 221 is assigned to “eth0”.

Each layer-2 tunnel 227 between edge device 118 and the container 209 has two legs: the GRE-TAP over WIREGUARD connection between edge device 118 and the machine instance 203, and the raw MacVLAN link between the instance's GRE-TAP interface and the container 209. The GRE packets inside the WIREGUARD connection is encrypted and protected by WIREGUARD cryptographic suite over Internet. The raw GRE packets transmitted between the container 209 and the machine instance 203 server interface may be unencrypted. The packet forwarding, encapsulation/decapsulation and encryption/decryption over the MacVLAN, GRE-TAP and WIREGUARD interfaces may be conducted in kernel mode completely.

In some embodiments, a cloud edge server 232 may be directly connected to a customer premises network 106. For example, the cloud edge server 232 may be a substrate extension of the cloud provider network 103, so that machine instances 203 and/or containers 209 including the edge applications 215 may be executed at the network edge, in this case, directly on the customer premises network 106. Applications may be executed on a cloud edge server 232, for example, if they are determined to be highly latency sensitive.

Moving on to FIG. 2B, shown is a networked environment 250 according to various embodiments. The networked environment 250 is a variation of the networked environment 200 (FIG. 2B) to support cloud-based large language models (LLMs). Such embodiments may the functionality of smart home devices through the use of cloud-based micro-large language models (micro-LLMs) to deliver advanced artificial intelligence capabilities. The proliferation of smart home technology has led to a significant increase in the demand for devices with advanced processing capabilities. However, many smart devices are limited by their inherent computational resources, which restricts their ability to perform sophisticated AI operations. Current solutions either require significant hardware upgrades or compromise on the capabilities of the algorithms used, limiting the effectiveness and range of smart home functionalities. Micro-LLMs, or micro large language models, are scaled-down versions of larger language models. They are designed to provide similar capabilities in natural language understanding and generation but are smaller in size, making them faster and less resource-intensive. This size reduction often means they can be deployed in environments where computing power or storage is limited, or where quicker response times are needed without a significant loss in performance accuracy compared to their larger counterparts.

Various embodiments address these limitations by implementing a system where micro-LLMs are hosted in the cloud, as edge applications 215 (FIG. 2B), thus providing AI capabilities to smart home devices without the need for extensive local processing power. This system includes a secure communication protocol ensuring data privacy and security, enabling real-time AI processing capabilities remotely.

As shown in FIG. 2B, a cloud-based AI engine 251 may be executed in the container 209. The cloud-based AI engine 251 may be executed to provide some additional functionality for devices on the customer premises network 106. The cloud-based AI engine 251 may include one or more LLMs 253 as well as training data 256 to train the LLM(s) 253. In various embodiments, the LLM 253 and the cloud-based AI engine 251 may be specific to the customer, or an instance specific to the customer. The LLM 253 may be trained based at least in part on training data 256 of the customer, where the customer has consented to the training use of the data. For example, the training data 256 may include data relating to smart home devices, streaming subscription data, broadband usage data, WI-FI data, and so on.

In this way, actions across the customer premises network 106 can be choreographed. For example, the LLM 253 based upon training and past usage, may initiate the following actions when a movie begins playing on a living room television: (1) lock the front door automatically by communicating with a smart door lock, (2) turn out the living room lights, and (3) make an announcement via a voice interface device that the movie is about to begin playing. Users in the household may have historically performed each of these activities in conjunction with playing a movie, so the LLM 253 will be programmed to recognize the pattern and may adopt it automatically, or ask the user to confirm that the pattern should be adopted.

In one embodiment, one LLM 253 may be trained to be specific to a premises, such as a home environment, while additional LLMs 253 may be trained to be specific to one or more particular users at the premises. For example, a first LLM 253 may be trained for a household, a second LLM 253 may be trained for a parent in the household, and a third LLM 253 may be trained for a child in the household. The LLMs 253 may be initially configured based upon a reference model, and then the models can be fine tuned based upon usage in the premises and/or by the particular users. That is to say, an action taking place in the home by a user may be used to fine tune or train both a home LLM 253 and an LLM 253 corresponding to that user.

In one scenario, a user-specific LLM 253 may be trained to recognize the user via face recognition. A smart home camera may routinely capture images of the user's face, and these may be used, with consent, for continued training of the user-specific LLM 253. In this way, the user-specific LLM 253 can adapt towards changes in the user's appearance, such as aging, differences in facial hair, glasses, hats, and so forth.

Edge devices 118a and 118b may be connected to the customer premises network 106. The cloud-based AI engine 251 provides AI-enhanced functionality 259 for the edge device 118b. For example, the edge device 118b may be a smart home device having one or more input devices 261 (e.g., microphones, cameras, environmental sensors) and/or one or more output devices 264 (e.g., displays, speakers, haptic outputs). The cloud-based AI engine 251 may process data captured from the input devices 261 and generate data to be output by the output devices 264. Such data may be exchanged in an encrypted form between the edge device 118b and the cloud-based AI engine 251. In various embodiments, the cloud-based AI engine 251 may provide AI-enhanced functionality 259 via the edge device 118a that also executes the tunnel agent 221.

In a smart home environment, micro-LLMs can be highly useful for enhancing voice-activated devices like smart speakers or home automation systems. For example, a micro-LLM could be embedded in a smart speaker to manage and respond to everyday queries and commands more efficiently. This could include controlling home lighting, adjusting the thermostat, managing security systems, or providing real-time responses to questions about weather or news, all while requiring less processing power and offering faster response times. This integration not only improves user interaction through natural language processing but also enhances the functionality of the smart home ecosystem, making it more intuitive and responsive to the homeowner's needs.

Micro-LLMs can also be used in smart homes for user or household profiling, which enhances personalization and convenience. For instance, a micro-LLM could learn from interactions with various household members to understand their preferences and routines. This understanding could be used to adjust settings automatically, such as the heating schedule, lighting preferences, or even suggesting meal recipes based on dietary preferences and past choices.

By recognizing who is speaking, the system could tailor responses and actions to individual preferences, such as playing a favorite playlist or setting an alarm based on the user's schedule. This level of personalization not only improves the user experience but also helps in energy management by adapting the home's functionalities to match the specific lifestyle of its residents.

By running micro-LLMs in the cloud and creating a secure tunnel to home devices, one could effectively extend advanced AI capabilities to even the simplest smart devices without the need for extensive local processing power. This approach would allow devices with limited hardware capabilities to still benefit from sophisticated AI features, such as personalized automation and voice recognition, by offloading the computational work to the cloud. The secure tunnel aspect ensures that data transmitted between the cloud and home devices remains safe from interception, addressing privacy and security concerns that are critical in smart home environments. This setup would essentially give users the best of both worlds: advanced AI processing capabilities with minimal hardware requirements at the edge, plus enhanced security and data privacy.

Running micro-LLMs for smart home applications like a whiteboard from the cloud offers several security benefits, including the following:

Centralized Security Management: By running the application in the cloud, a customer benefits from the cloud provider's robust security measures, which are typically much stronger than what individual users might implement on their own. This includes advanced threat detection systems, security protocols, and regular security audits.

Data Backups: Cloud providers often offer integrated data backup solutions that automatically save and replicate data across multiple locations. This redundancy helps protect against data loss due to hardware failures, natural disasters, or cyber-attacks.

Up-to-Date Security: Cloud platforms regularly update their infrastructure with the latest security patches and protocols without requiring user intervention. This helps in defending against new threats and maintaining strong security standards.

Scalable Security Solutions: As customer needs grow, cloud-based systems can easily scale up security measures to handle increased loads or emerging threats without the need for significant additional investment from the customer.

Expert Monitoring: Many cloud providers offer 24/7 security monitoring, which means that any suspicious activity can be quickly identified and addressed, often before it becomes a significant threat.

These benefits help ensure that sensitive data related to a smart home's whiteboard application is well-protected while leveraging the processing power and capabilities of cloud-based micro-LLMs.

On the other hand, security is a critical aspect when considering running micro-LLMs in the cloud, especially for applications in smart homes where personal data is involved. Some key security considerations include:

1. Data Encryption: Data may be encrypted both in transit and at rest. Encrypting the data that travels between the cloud and home devices via secure tunnels (like VPNs or TLS) ensures that even if data is intercepted, it remains unreadable.

2. Access Controls: Strict access controls may be implemented to ensure only authorized devices and users can connect to the cloud services. This includes using strong authentication mechanisms to verify the identity of devices and users.

3. Regular Updates and Patches: Ensuring that both the cloud software and the home devices are regularly updated with the latest security patches is crucial to protect against vulnerabilities.

4. Network Security: Besides secure tunnels, additional network security measures such as firewalls, intrusion detection systems, and anti-malware solutions can help protect the data exchanged between the cloud and home devices.

5. Privacy Compliance: Comply with relevant privacy regulations, like the General Data Protection Regulation (GDPR) or the California Consumer Privacy Act (CCPA), which govern the collection, storage, and processing of personal data. This involves implementing measures to ensure user data is handled securely and transparently.

6. Data Minimization: Only collect and send the necessary data to the cloud. Reducing the amount of sensitive data processed and stored in the cloud can minimize the impact of a potential data breach.

7. Monitoring and Auditing: Implement monitoring tools to track usage and detect unusual activities in real-time. Regular audits can help ensure that the security measures are effective and that the system complies with security policies.

Running micro-LLMs in the cloud can be cost-effective, particularly when compared to deploying larger, full-scale models directly on devices or maintaining them on-premise. Here are a few points about the cost-effectiveness and pricing considerations:

1. Scalability: Cloud services typically offer scalable options where a customer only pay for the computational resources that the customer uses. This can be more economical than investing in and maintaining the customer's own server infrastructure.

2. Maintenance and Updates: Cloud providers handle the maintenance and updates of the infrastructure, reducing the burden on the customer end for ongoing hardware upkeep and software updates. This can significantly lower operational costs.

3. Energy Efficiency: Running AI processes in the cloud can be more energy-efficient compared to running them on local devices, especially if the devices are not optimized for high-efficiency processing.

4. Resource Optimization: With cloud computing, customers can dynamically allocate and deallocate resources based on demand, which means the customers are not paying for idle resources. This can be particularly beneficial if the demand for AI processing fluctuates.

5. Initial Costs: There are minimal initial costs since there is no need for heavy investment in hardware for the users. The cloud platform may bear the cost of the computational power and data storage.

System components may include a cloud-based AI engine 251, a secure communication protocol, and a smart home interface. The cloud-based AI engine 251 may host micro-LLMs capable of processing natural language queries, controlling smart home devices, personalizing user interactions based on historical data, and optimizing home energy usage based on learned patterns. The secure communication protocol utilizes advanced encryption standards and secure tunneling mechanisms, such as VPNs or TLS, to ensure that all data transmitted between the cloud and home devices is securely protected against unauthorized access and potential cyber threats. A smart home interface is a software layer installed on smart home devices that facilitates communication with the cloud-based AI engine, sending user queries and device data to the cloud and receiving commands or processing results.

Smart home devices continuously collect data relevant to user commands, environmental conditions, and device performance. Data is securely transmitted to the cloud where the micro-LLMs are hosted. The cloud-based AI engine processes the received data, leveraging micro-LLMs to generate insights, make decisions, or create personalized user experiences. The processed commands or insights are transmitted back to the smart home devices for execution or display.

The micro-LLMs can adapt over time to the preferences and routines of individual users, optimizing the smart home environment for better energy usage, enhanced security, and greater comfort. The system can analyze data collected from smart home devices to predict potential maintenance issues or failures before they occur, proactively notifying users and scheduling maintenance automatically.

Security features include advanced encryption both in transit and at rest to safeguard user data and commands from eavesdropping or tampering. Regular security updates and maintenance ensures that both the cloud software and the smart home devices are regularly updated with the latest security patches to protect against vulnerabilities. Adhering to international privacy standards such as GDPR or CCPA, ensuring that user data is handled securely and with the highest respect for user privacy.

While the LLMs 253 are shown as executed in the cloud provider network 103, in some embodiments, one or more LLMs 253 may be executed on a cloud edge server 232 that is directly connected to the customer premises network 106. For example, a device or server on the customer premises network 106 may have capacity in terms of processor and memory to execute the LLM 253, which would reduce latency.

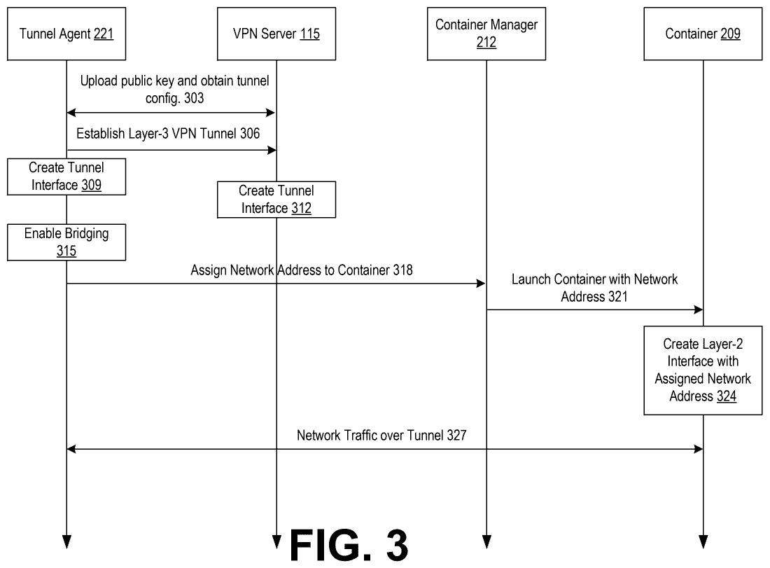

Turning now to FIG. 3, shown is a sequence diagram 300 showing how edge devices 118 work with the VPN server 115 and the container manager 212 to launch a container 209 with an edge application 215 and establish the related layer-3 tunnel 224 and layer-2 tunnel 227. The edge device 118 may be registered to the cloud provider network 103 through an onboarding process. Consequently, a persistent HTTPS or Message Queuing Telemetry Transport (MQTT)-based TLS connection can be used as the signaling channel between the edge device 118 and the cloud provider network 103 to exchange the commands described below.

At 303, the tunnel agent 221 on the edge device 118 generates a per-device public/private key pair for the layer-3 tunnel 224. The tunnel agent 221 may register itself to the VPN server 115 by uploading its public key through another, potentially pre-existing secure channel (like a HTTPS/MQTT TLS connection). The VPN server 115 adds the edge device 118 into the trusted-peer database and returns the peer configuration including the assigned IPv6 address to the tunnel agent 221.

At 306, the tunnel agent 221 establishes the outer layer-3 tunnel 224 with the VPN server 115 and applies the assigned IPv6 addressing over the created “wg0” interface. The tunnel agent 221 then generates an IPv4 address for the inner layer-2 tunnel 227. The IPv6 address and other settings such as DNS server and default gateway for the remote cloud container are obtained from customer premises network's DHCP server.

At 309, the tunnel agent 221 creates the inner layer-2 tunnel 227 interface (“gr0”, for example) using VPN server's IPv6 address as remote peer address. At 312, the VPN server 115 also creates the inner layer-2 tunnel 227 interface (grX) using the edge device's IPv6 address as remote peer address. In this way, the layer-2 tunnel 227 is established for the container 209.

At 315, the tunnel agent 221 enables bridging over the created layer-2 tunnel 227 interface with its Ethernet (or Wi-Fi) interface. The layer-2 tunnel 227 is attached to the customer premises network 106 through the bridging. At 318, the tunnel agent 221 passes the generated IPv4 address and configuration to the cloud-side container manager 212.

At 321, the container manager 212 starts a new container 209 to run the edge application 215. In one embodiment, the network type of the container 209 will be MacVLAN whose parent device is the “grX” created in the machine instance 203 for the container 209. The IPv4 configuration obtained from edge device 118 is passed to the container 209.

At 324, during the launch of the container 209, a layer-2 interface 218b is created with the virtual MacVLAN interface “eth0,” which configured with the assigned customer premises network's IPv4 address, DNS server and default gateway. With those IPv4 configuration settings, the container 209 can be virtually and directly attached to the customer premises network 106. With the layer-2 tunnel 227 between the container 209 and edge device 118 being fully established, at 327, the network traffic from the edge application 215 executed in the container 209 will be forwarded through the layer-2 tunnel 227 using local addressing of the customer premises network 106.

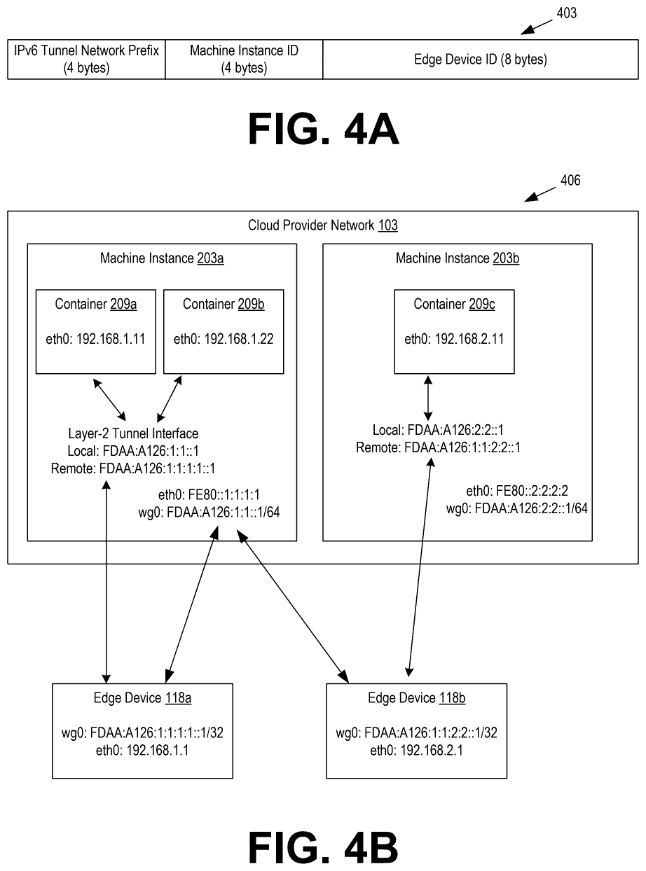

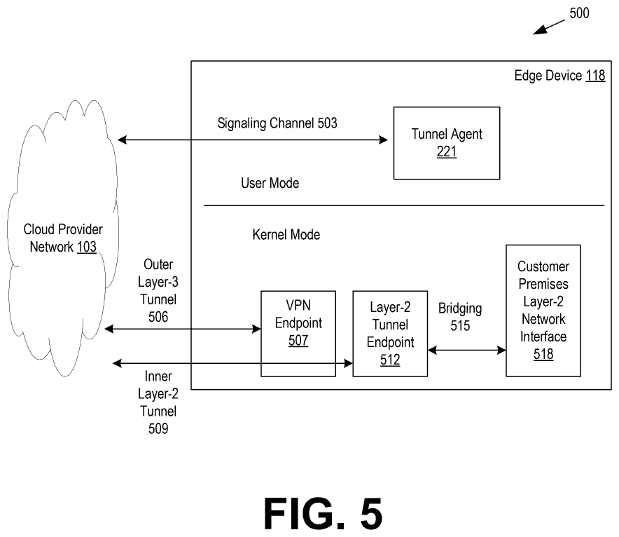

Continuing to FIG. 4A, shown is one example of a format 403 employed for IPv6 network addressing by the VPN server 115. In this non-limiting example, the format 403 may include a IPv6 tunnel network prefix (4 bytes), an identifier of the machine instance 203 (4 bytes), and an identifier of the edge device 118 (8 bytes). Over the layer-3 tunnels 224, a private virtual IPv6 network is formed to support the communication among edge devices 118, cloud services 206, and containers 209. The private network may be created using the IPv6 subnets with predefined unique local address (ULA) prefixes as illustrated with the format 403.

Referring next to FIG. 4B, shown is a networked environment 406 with multiple edge devices 118 on a customer premises network 106 extended to the cloud provider network 103. FIG. 4B also demonstrates an example of the private IPv6 networks can used to create the inner layer-2 tunnels 227 among edge device 118a, edge device 118b, and their containers 209a, 209b, 209c executed in the cloud provider network 103. In the example of FIG. 4B, the edge devices 118a, 118b are both connected to machine instance 203a. This machine instance 203a will be the home gateway to let edge devices 118a, 118b communicate with other machine instances 203 inside the same virtual private cloud or cloud provider network 103. The container manager 212 can launch containers 209 running inside the same home machine instance 203 of the edge device 118 or any other non-home machine instances 203. In FIG. 4B, the containers 209a, 209b of the edge device 118a are running inside home machine instance 203a. However, the container 209c of the edge device 118b is running inside a different machine instance 203b. In this example, all machine instances 203 may be equally running two functions: a container 209 and a VPN server 115. As such, an IPv6 address and routing plan is developed to allow edge devices 118 and their containers 209 to exchange data with each other over the internal IPv6 virtual network created by the VPN server 115.

In the example of FIG. 4B, the prefix is a four-byte unique local addressing (ULA) value “FDAA:A126.” Each machine instance 203 has a four-byte unique instance identifier (ID). One machine instance 203 and its connected edge devices 118 will obtain the addresses within a subnet defined by the prefix and the unique instance ID. Each edge device 118 may have an eight-byte unique device ID. An edge device 118 creates the IPv6 address using the prefix, the ID of the machine instance 203a and the device ID. In the local/remote addresses used to establish the layer-2 tunnel 227 between the edge device 118 and its containers 209, the instance ID part could be different since the edge device 118 and its containers 209 can be hosted by different machine instances 203. In some implementations, the device ID can be derived from edge device's serial number or other unique ID like medium access control (MAC) address used by the cloud provider network 103 to identify client devices.

In one implementation, the VPN server 115 assigns an IPv6 address as “prefix:instance-ID::1” to its layer-3 tunnel interface (“wg0”). In the example of FIG. 4B, the machine instance 203a has a four-byte ID “0x00010001” (“1:1”), and its IPv6 subnet is “FDAA:A126:1:1::164,” and its layer-3 tunnel interface address is “FDAA:A126:1:1::1.”

In the example, edge device 118a with ID “0x00010001” (“1:1”) is connecting to machine instance 203a with ID “0x00010001” (“1:1”). As such, the address of the “wg0” interface for edge device 118a is “FDAA:A126:1:1:1:1::1.” Similarly, the address of the “wg0” interface for edge device 118b is “FDAA:A126:1:1:2:2::1.”

When the container manager 212 launches containers 209 on a machine instance 203 for an edge device 118, a layer-2 tunnel 227 is established. Both the edge device 118 and the machine instance 203 create the layer-2 tunnel interfaces on their ends using the peer's IPv6 address as the remote address for the layer-2 tunnel interface. In the example of FIG. 4B, the layer-2 interface (“gr1”) of the machine instance 203a with the edge device 118a has remote IPv6 address “FDAA:A126:1:1:1:1::1” and local IPv6 address “FDAA:A126:1:1::1.” The layer-2 interface (“gr1”) of the machine instance 203b with edge device 118b has remote IPv6 address “FDAA:A126:1:1:2:2::1” and local IPv6 address “FDAA:A126:2:2::1.”

Since all machine instances 203 have their own IPv6 subnets (prefix:instance-ID::/64) on “wg0” interfaces, by default all of the edge devices 118 can be reachable through the “wg0” interface of connected home machine instances 203. In one example, the machine instance 203 needs to know how to conduct IPv6 routing for every other instance over the “eth0” interface, which is used to relay the layer-2 traffic from locally hosted edge devices 118 and/or containers 209 to edge devices 118 and/or containers 209 running on other machine instances 203. Such routing settings can be created on demand when the container manager 212 launches a container 209 on the machine instance 203 by leveraging IPv6 Neighbor Discovery Protocol (NDP) proxy. In order to create the NDP proxy entries, the container manager 212 on one machine instance 203 only needs to know which IPv6 addresses of the edge devices 118 connected to the local layer-3 interface (“wg0”) shall be advertised through ethernet interface (eth0) for other machine instance 203.

When the machine instance 203a is launched, it creates its local VPN server 115 with address “FDAA:A126:1:1::1/64” over the layer-3 “wg0” interface and creates a routing entry for general “FDAA:A126::/32” subnet over the ethernet “eth0” interface. In other words, the local connected edge device 118 with the “FDAA:A126:1:1::/64” prefix will be reachable through “wg0” and other non-local subnets hosted by other machine instances 203 that are reachable through “eth0” interface. The machine instance 203b conducts the same process to assign address “FDAA:A126:2:2::1/64” over the layer-3 “wg0” interface and create a routing entry for general “FDAA:A126::/32” subnet over its own ethernet “eth0” interface. Machine instances 203a, 203b also add a NDP proxy entry for the local “wg0” address over the “eth0” interface ((“ip −6 neigh add proxy fdaa:a126:1:1::1 dev eth0” and “ip −6 neigh add proxy fdaa:a126:2:2::1 dev eth0”)), which is used for routing layer-2 traffic for each other later while bypassing the customer premises network 106.

In this example, when edge devices 118a, 118b establish layer-3 tunnels 224 to machine instance 203a, they are assigned IPv6 addresses “FDAA:A126:1:1:1:1::1” and “FDAA:A126:1:1:2:2::1,” respectively. Machine instance 203a may add the NDP proxy entries over “eth0” for the edge devices 118: “ip −6 neigh add proxy fdaa:a126:1:1:1:1::1 dev eth0” and “ip −6 neigh add proxy fdaa:a126:1:1:2:2::1 dev eth0”. Then the kernel's IPv6 stack will start to reply neighbor advertisements (NA) to other neighbor solicitations from other machine instances 203 over the “eth0” interface.

When the machine instance 203a launches the containers 209a, 209b, the machine instance 203a creates the layer-2 interface “gr1” with local address “FDAA:A126:1:1::1” and remote address “FDAA:A126:1:1:1:1::1.” Since according to local routing table, “FDAA:A126:1:1:1:1::1” is reachable over local interface “wg0,” the layer-2 traffic for containers 209a, 209b will be routed locally inside machine instance 203a without involving machine instance 203b.

When machine instance 203b launches the container 209b, it creates the layer-2 interface “gr1” with local address “FDAA:A126:2:2::1” and remote address “FDAA:A126:1:1:2:2::1.” According to the routing table of machine instance 203b, “FDAA:A126:1:1:2:2::1” is reachable through “eth0.” The machine instance 203b then sends a neighbor solicitation (NS) over “eth0” to ask who has the address “FDAA:A126:1:1:2:2::1.” The machine instance 203a receives the NS and based on its NDP proxy table for “FDAA:A126:1:1:2:2::1,” it replies NA to the machine instance 203b to claim the MAC address of “FDAA:A126:1:1:2:2::1” is its own “eth0” 's MAC address. The machine instance 203b sends the machine instance 203a the GRE-TAP packets with destination address “FDAA:A126:1:1:2:2::1” and source address “FDAA:A126:2:2::1.” The machine instance 203a forwards those packets to the edge device 118b over the “wg0” interface. When edge device 118b sends back reverse GRE-TAP packets with destination address “FDAA:A126:2:2::1” and source address “FDAA:A126:1:1:2:2::1” over the layer-3 tunnel 224 to machine instance 203a, the machine instance 203a conducts the NDP discovery over the “eth0” interface (since “FDAA:A126:2:2::1” is reachable over “eth0” according to its routing table) to ask who has address “FDAA:A126:2:2::1.” The machine instance 203b will reply with NA using its “eth0” MAC address. Then machine instance 203a will continue to forward the GRE-TAP traffic between edge device 118b and machine instance 203b in both directions.

Another way of implementing configuration of the NDP proxy is to deploy a user-mode NDP proxy server running on all machine instances 203 over the Ethernet interface “eth0”. Instead of using kernel NDP proxy to add the layer-3 addresses of the edge devices 118 explicitly one by one, the NDP proxy servers may handle neighbor solicitations for the IPv6 subnets of their machine instance 203 in general. For example, the NDP proxy server daemon (“ndp_proxy”) on machine instance 203a can be started as “ndp_proxy −i eth0 fdaa:a126:1:1::/64.” On the machine instance 203b, the NDP proxy server can be started as “ndp_proxy −i eth0 fdaa:a126:2:2::/64.” The NDP proxy server then will reply NA responses to NS requests targeted for their own subnets (“fdaa:a126:1:1::/64” and “fdaa:a126:2:2::/64”) with the MAC addresses of their respective layer-2 “eth0” interface.

Since the layer-3 virtual private network within the virtual private cloud network may support multi-tenancy architecture, routing policy rules among the containers 209, machine instances 203, and edge devices 118 may be used to isolate the edge devices 118 and containers 209 belonging to different customers, users, or accounts. In order to enforce the per-user routing policy, the eight-byte edge device 118 identifier in the IPv6 address may contain a six-byte customer ID followed by a two-byte device ID.

With the customer ID in the IPv6 address of the layer-3 virtual private network, several routing rules may be enforced. For example, containers 209 may be restricted to communicate only with its own edge device 118 to establish the layer-2 tunnel 227, while other IPv6 traffic from/to the container's layer-2 “eth0” interface may be dropped. This rule may be enforced by the MacVLAN configuration. Since the container's MacVLAN (“eth0”) interface's host-side parent network device is the layer-2 interface 218b connecting to the corresponding edge device 118, the container 209 can only communicate with its customer's edge device(s) 118 over the cloud IP tunnel infrastructure.

On edge device 118 side over the layer-3 interface, a firewall rule establishes that the edge device 118 may communicate using the IPv6 address containing the same eight-byte edge device ID of this edge device 118. Furthermore, in one implementation, only GRE-TAP traffic is allowed, while all other packets may be dropped over the layer-3 VPN interface.

On the cloud side, all machine instances 203 may enforce the IPv6 routing rules to disallow forwarding packets that belong to different customers or users by checking the six-byte customer ID in the source and destination IPv6 addresses in each packet. The customer ID in source address may be required to be the same as the customer ID in the destination address.

Using the network topology example in FIG. 4B, the downlink packet flow between the edge device 118a and its container 209a involves the steps described as follows. The container 209a with assigned IP address “192.168.1.11” sends a packet to cloud service 206 “1.1.1.1” using the transmission control protocol (TCP) socket API. Since “eth0” is the default interface for Internet access for the container 209, the kernel mode TCP/IP stack generates an IP packet with eth0's IP address (“192.168.1.11”) as source address and “1.1.1.1” as the destination address.

The kernel mode MacVLAN interface in the container 209a receives the raw Ethernet packet through the “eth0” interface and forwards it to the parent GRE-TAP interface gr1. GRE-TAP encapsulates the Ethernet packet into an IPv6 GRE packet and forwards it to host WIREGUARD interface “wg0” of the machine instance 203. The GRE packet has the WIREGUARD IPv6 address (“fdaa:a126:1:1::1”) as source address and the target edge device 118a (“fdaa:a126:1:1:1:1::1”) as destination address.

The WIREGUARD kernel module in machine instance 203 encrypts the GRE packet and encapsulates it as an IPv4 UDP packet and forwards it to edge device 118a over the established WIREGUARD tunnel. After exiting the cloud provider network 103 and transiting over the Internet, the WIREGUARD UDP packet uses the public IP address of machine instance 203a (“X.X.X.X”) as the source address and the public IP address (“Y.Y.Y.Y”) of the edge device 118a as the destination address.

A router at the customer premises network 106 conducts network address translation (NAT) over the WIREGUARD user datagram protocol (UDP) packet and forwards the packet to the edge device 118a. Now the UDP packet has the local IP address (192.168.1.1) of the edge device 118b as the destination address. The WIREGUARD kernel module of the edge device 118a receives the UDP packet. The module decrypts the packet and removes the IPv4 and WIREGUARD UDP header to recover the original raw Ethernet IPv6 GRE payload, and then relays it to GRE-TAP interface “gr0”.

Kernel mode GRE-TAP removes the IPv6 GRE header to recover the original Ethernet packet generated by the container 209a. After bridging, the raw packet is transmitted over the physical ethernet or Wi-Fi interface of the edge device 118a to the router of the customer premises network 106, with “192.168.1.11” as source IP address and “1.1.1.1” as destination IP address. The router will forward the packet to cloud service 206 “1.1.1.1” using the public IP address (“Y.Y.Y.Y”) of the customer premises network 106.

If the container 209a desires to communicate with the devices located on the local network of the customer premises network 106 with an IP address such as “192.168.1.10,” the flow is similar. The container 209 may employ broadcast-based packets for IPv4 address resolution protocol (ARP) and multicast-based IPv6 neighbor discovery protocol (NDP), which may be directly forwarded over the GRE-TAP tunnel onto the local customer premises network 106.

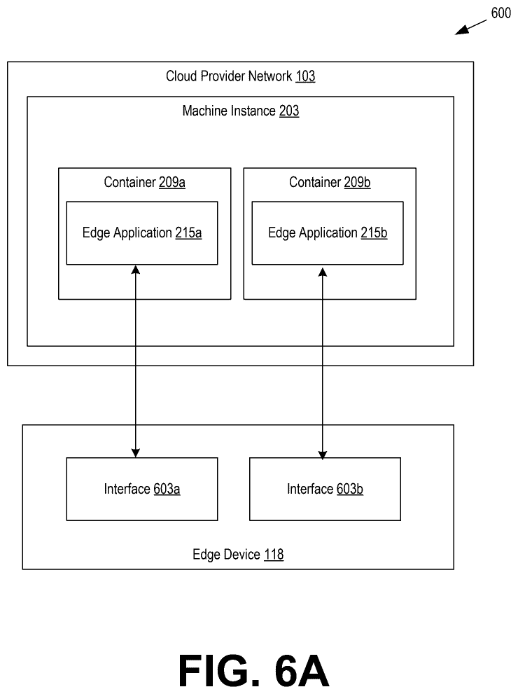

Moving on to FIG. 5, shown is a networked environment 500 illustrating one example implementation of an on-device agent or software development kit (SDK) in an edge device 118. An on-device agent, such as the tunnel agent 221, executed in the edge device 118 implements the management plane to work with cloud provider network 103 infrastructure using the TLS signaling channel 503 to create two types of tunnel: the outer layer-3 tunnel 506 (“wg0”) with cloud VPN server 115 and the inner layer-2 tunnels 509 (“grX”) with the cloud application containers 209.

The tunnel agent 221 first generates public/private public key pairs and registers the public key to the cloud VPN server 115 through the existing TLS signaling channel 503. The VPN server 115 adds the public key to its “wg0” interface and returns a layer-3 VPN configuration profile to the edge device 118. In the configuration, the per-device IPv6 address and cloud home machine instance's IPv6 addresses are specified. The tunnel agent 221 applies the configuration to create the “wg0” interface and establish the outer layer-3 tunnel 506 with the VPN endpoint 507.

During launching of the containerized edge applications 215, the container manager 212 may communicate with the VPN server 115 to return a target container machine instance's IPv6 address. Using this machine instance 203 address, the tunnel agent 221 creates the inner layer-2 tunnels 509 to the layer-2 tunnel endpoint 512 and corresponding “grX” interfaces. The layer-2 tunnel endpoint 512 may perform bridging 515 to the customer premises layer-2 network interface 518.

The tunnel agent 221 also calls the network manager of the edge device 118 to setup the kernel mode routing or bridging rules between “grX” and Ethernet/Wi-Fi interfaces. The tunnel agent 221 enables bridging mode by using a DHCP request to obtain a local IPv4 address from a router on the customer premises network 106. The local IP address is assigned to the container 209 for the edge application 215 through the TLS signaling channel 503. If multiple simultaneous edge applications 215 hosted by different machine instances 203 are desired, the tunnel agent 221 may create multiple IP addresses and multiple layer-2 interfaces and tunnels for those apps. Those containers 209 may share the same outer layer-3 tunnel 506 to create the inner layer-2 tunnel 509, e.g., using GRE-TAP.

In bridging mode, multicast internet control messaging protocol version 6 (ICMPv6) packets like router solicitation (RS), router advertisement (RA), neighbor solicitation (NS) and neighbor advertisement (NA) may be forwarded over the inner layer-2 tunnel 509, thereby allowing the containers 209 to obtain IPv6 addresses from a DHCP server on the customer premises network 106 using IPv6 Stateless Address Autoconfiguration (SLAAC). As such, IPv6 based applications like MATTER can be supported through the inner layer-2 tunnel 509.

To avoid forwarding unnecessary multicast packets from the customer premises network 106 to cloud containers 209 in bridging mode, the tunnel agent 221 could enable multicast internet group management protocol (IGMP) or multicast listener discovery (MLD) snooping to learn which multicast group traffic that the cloud containers 209 are receiving. Subsequently, only the relevant multicast packets on the customer premises network 106 are forwarded to the cloud containers 209.

The tunnel agent 221 executed in the edge device 118 may be cloud managed, which means tunnel agent 221 receives the commands from cloud side to add and/or remove the containers 209 and the required tunnels. The tunnel agent 221 may establish the IP tunnels to connect the containers 209 with the customer premises network 106. All of application layer business logic may be implemented on cloud side and therefore may be transparent to the tunnel agent 221. As such the tunnel agent 221 may utilize small amounts of computing resources (e.g., compute, memory, storage) on edge devices 118, which makes the tunnel agent 221 portable and capable of deployment on highly resource constrained edge CPE devices.

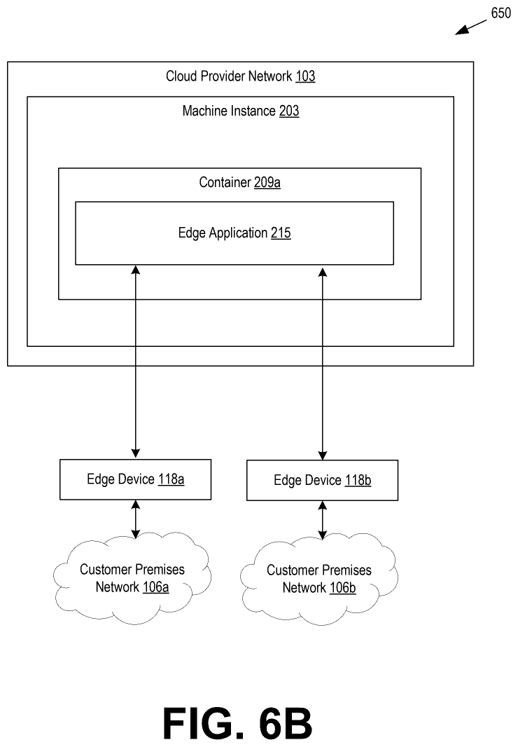

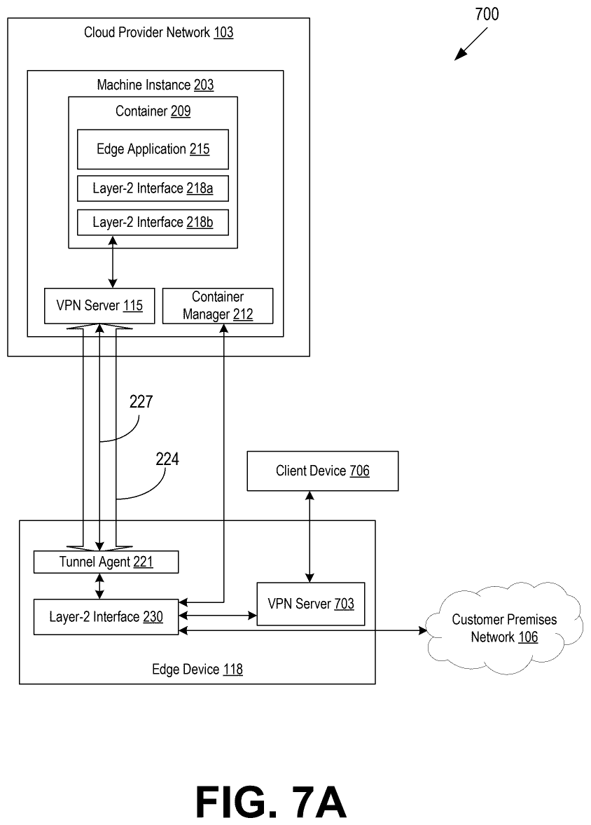

FIG. 6A shows a networked environment 600 illustrating resource mappings. Over the IP tunnel between the edge device 118 and its application containers 209a, 209b on the cloud provider network 103, various local resources on the edge device 118 and customer premises network 106 (e.g., hardware interfaces 603a, 603b) can be mapped to the cloud side and become accessible to the containers 209 transparently. Such transparent remote access can be fulfilled over IP through the GRE-TAP over Wireguard tunnel. For example, the ZIGBEE or Z-WAVE USB radios attached to edge devices 118 can be mapped to cloud container 209 instances using USB over IP, which become virtual local USB devices that can be accessed by the native ZIGBEE or Z-WAVE middleware stacks running inside the edge applications 215a, 215b in the containers 209a, 209b. Other devices and protocols can be used in other examples, such as an RS-232 serial port and RS-232 over IP. Moreover, the containers 209 can then communicate with other devices on the customer premises network 106 that are accessible only through the ZIGBEE or Z-WAVE USB radio.

In various embodiments, a MATTER software stack on the edge device 118 may be a resource that is accessible by edge applications 215 in the cloud provider network 103. Traditionally, the MATTER protocol and THREAD connections have been used exclusively in local networks. By exposing the MATTER software stack, a MATTER controller may be executed as an edge application 215 in the cloud provider network 103, and THREAD connections may be made from the cloud to the premises and vice versa.

FIG. 6B is a drawing of a networked environment 650 that uses the cloud provider network 103 to link or connect multiple customer premises networks 106a and 106b. Using the principles described elsewhere herein, an edge device 118a may connect to the edge application 215 and thereby expose a hardware or software interface to the customer premises network 106a. In addition, an edge device 118b may connect to the edge application 215 and thereby expose a hardware or software interface to the customer premises network 106b.

In this way, the edge application 215 is able to be on both customer premises networks 106a and 106b. In some scenarios, the edge application 215 may act as a controller and/or provide some type of functionality to devices on the customer premises networks 106a, 106b. In other scenarios, the edge application 215 may act as a gateway or bridge to connect both of the customer premises networks 106a, 106b, so that a device on the customer premises network 106a can communicate with a device on the customer premises network 106b as if they each were on the respective local network.

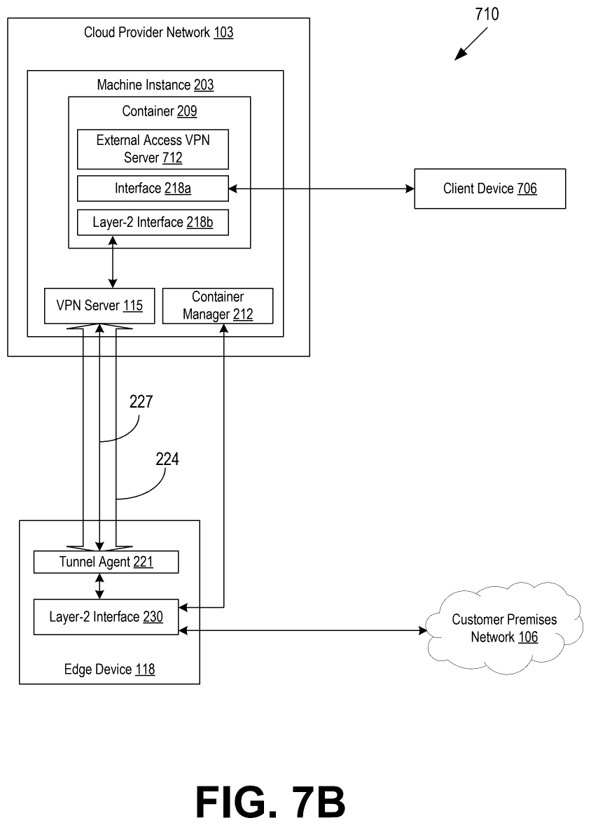

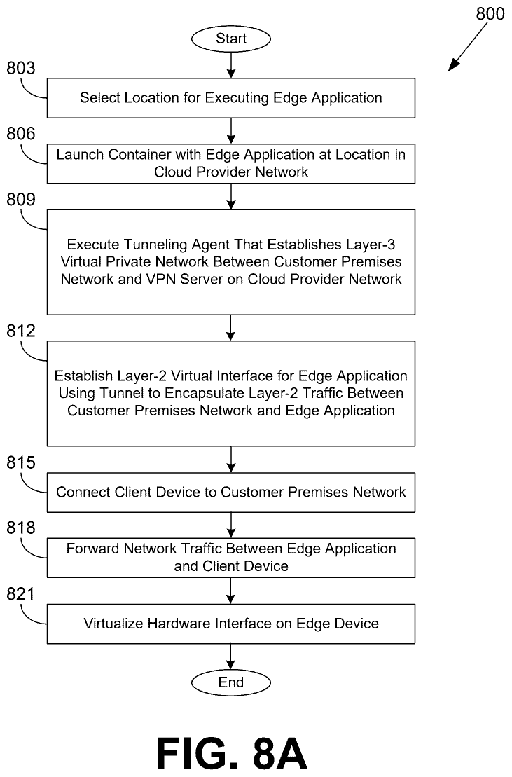

FIG. 7A is a drawing of a networked environment 700 illustrating the use of native VPN servers 703 in edge devices 118. When the edge device 118 is able to obtain a public IP address from an internet service provider, the edge device 118 can launch the local native VPN servers 703 like WIREGUARD or OPENVPN directly. With this in-device native VPN server solution, the cloud provider network 103 only needs to provide a Dynamic DNS service to register a persistent public DNS name for the edge device 118. The cloud provider network 103 generates the client profiles for the standard WIREGUARD or OPENVPN phone apps using the edge device's DNS name, per-client VPN credentials (public key, X509 certificate etc.) and IP addressing. The end user can just install the standard WIREGUARD or OPENVPN client applications on their client devices 706 (e.g., smartphones, laptop computers, tablet devices, etc.) and import such profiles. After that, the end user can remotely connect to their customer premises network 106 anywhere by establishing the VPN connections to VPN servers 703 running on the edge devices 118. The edge devices 118 may allow end users to access the hosts on the local customer premises network 106 and the containers 209 on the cloud provider network 103.

FIG. 7B is a drawing of a networked environment 710 illustrating the use of native external access VPN servers 712 as cloud container applications. If the edge device 118 is behind a NAT network and unable to obtain a public IP address, the cloud provider network 103 could offer the public IP address and corresponding DNS names from the cloud side and run the native WIREGUARD or OPENVPN servers inside cloud container apps for the edge device 118. Then end users just use the same standard WIREGUARD or OPENVPN client phone applications on the client devices 706 to connect to the cloud container-based external access VPN servers 712 via the interface 218a of the container 209 (or of the machine instance 203). The interface 218a may be a layer-2 or a layer-3 interface. The external access VPN servers 712 inside the containers conduct the IP forwarding between the VPN interface (“wg0” or “tun0”) and the MacVLAN “eth0” interface. As such, the client devices 706 are able to access their local customer premises networks 106 and also other containers 209 on the cloud provider network 103.

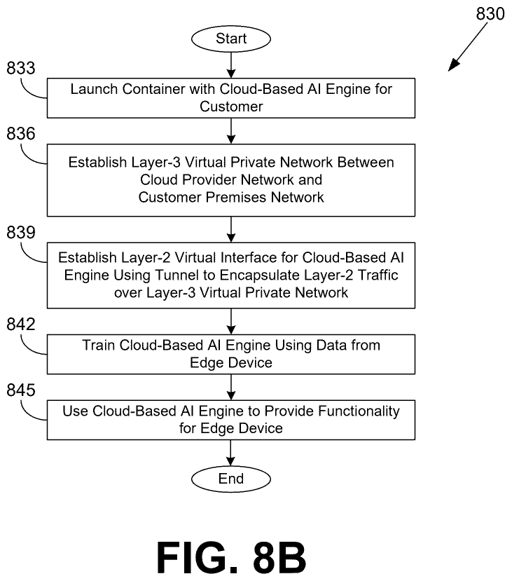

Referring next to FIG. 8A, shown is a flowchart 800 that provides one example of the operation of a portion of the networked environment 200 according to various embodiments. It is understood that the flowchart 800 of FIG. 8A provides merely an example of the many different types of functional arrangements that may be employed to implement the operation of the portion of the networked environment 200 as described herein. As an alternative, the flowchart 800 of FIG. 8A may be viewed as depicting an example of elements of a method implemented in the networked environment 200 according to one or more embodiments.

Beginning with box 803, a location may be selected for executing an edge application 215 that is to be executed in the cloud provider network 103 as an extension of the customer premises network 106. The customer premises network 106 of the customer may use private network addresses and may be separated from a public network by a gateway (e.g., a NAT router). For example, the location may be a particular region, availability zone, local zone, edge location, etc., within the cloud provider network 103. The particular location may be determined based at least in part on a proximity of the location to the customer premises network 106 or a latency between the location the customer premises network 106.

In box 806, once the location is selected, a container 209 is launched with the edge application 215 at the location in the cloud provider network 103. In box 809, a tunneling agent 221 is executed on an edge device 118 in the cloud provider network 103 that establishes a layer-3 VPN between the customer premises network 106 and the VPN server 115 on the cloud provider network 103.

In box 812, a layer-2 virtual interface is established for the edge application 215 in the container 209 using a tunnel to encapsulate the layer-2 traffic between the customer premises network 106 and the edge application 215 executed in the container 209. The edge application 215 may be configured to generate a graphical user interface and then encode the graphical user interface for rendering by another device on the customer premises network 106. Traffic between a plurality of edge applications 215 that are on the extended customer premises network 106 in the cloud provider network 103 may bypass the tunnel. In one embodiment, the edge application is able to control an edge customer premises equipment (CPE) device on the customer premises network 106 via the layer-2 data connection. The edge application 215 may be assigned a network address, such as a layer-3 network address, on the customer premises network 106. The edge application 215 may communicate with one or more services on a virtual private cloud network in the cloud provider network 103. In some implementations, the edge application 215 may encode data obtained from an edge CPE device for streaming and/or storage.

In box 815, a client device 706 may connect to the customer premises network 106, either through a VPN server executed on a container 209, or through a VPN server executed on an edge device 118. The client device 706 may be assigned a network address on the customer premises network 106, e.g., by a DHCP server 231. In box 818, network traffic may be forwarded between the edge application 215 and the client device 706.

In box 821, the tunneling agent 221 may map and/or virtualize a hardware or software interface 603 on the edge device 118, exposing it to the containers 209 and the edge applications 215 executed in the cloud provider network 103. The hardware interface 603 may comprise a hardware radio interface supporting at least one of: Z-WAVE, ZIGBEE, BLUETOOTH low energy, or LORAWAN, or the hardware interface 603 may comprise a hardware communication port supporting at least one of: RS-232 serial communication or universal serial bus (USB). For example, the radio interface may be a radio interface to a mesh network. Multiple hardware interfaces 603 may be present and mapped such that the hardware interfaces 603 are accessible by the edge application 215 via a tunnel. One or more IoT devices may be controlled via the hardware interface 603. In one embodiment, the edge application 215 is configured to control one or more IoT devices through the hardware interface 603. Data may be sent by the edge application 215 to another device via the hardware interface 603, and data may be received from the other device via the hardware interface 603 by the edge application 215. In some cases, the edge application 215 may receive data via a hardware interface 603 that is a radio interface where the data is sent by another device on the customer premises that is not directly connected to the customer premises network (e.g., a Z-WAVE device not connected to Ethernet or WIFI). Thereafter, the flowchart 800 ends.

Referring next to FIG. 8B, shown is a flowchart 830 that provides one example of the operation of a portion of the networked environment 250 according to various embodiments. It is understood that the flowchart 830 of FIG. 8B provides merely an example of the many different types of functional arrangements that may be employed to implement the operation of the portion of the networked environment 250 as described herein. As an alternative, the flowchart 830 of FIG. 8B may be viewed as depicting an example of elements of a method implemented in the networked environment 250 according to one or more embodiments.

Beginning with box 833, a container is launched with a cloud-based AI engine 251 that is intended to be specific to a customer. In box 836, a layer-3 virtual private network is established between the cloud provider network 103 and the customer premises network 106. In box 839, a layer-2 virtual interface is established for the cloud-based AI engine 251 using a tunnel to encapsulate layer-2 traffic over the layer-3 virtual private network.

In box 842, the cloud-based AI engine 251 is trained using data from an edge device 118. For example, portions of the training data 256 for an LLM 253 may be captured from an input device 261 of the edge device 118.

In box 845, the cloud-based AI engine 251 is used to provide AI-enhanced functionality 259 for the edge device 118. For example, the functionality may involve returning some output (e.g., a voice response) via an output device 264 (e.g., speaker) of the edge device 118. Thereafter, the flowchart 830 ends.

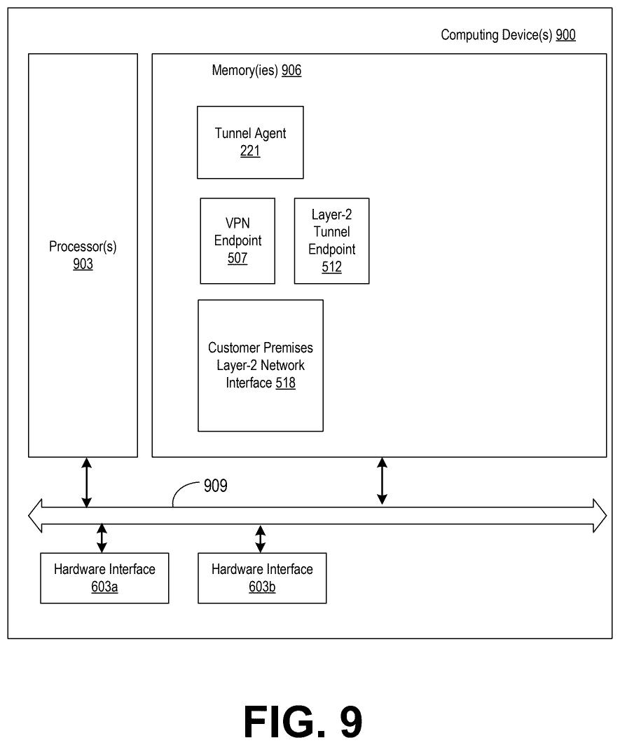

With reference to FIG. 9, shown is a schematic block diagram of a computing device 900 used as an edge device 118 according to an embodiment of the present disclosure. The computing device 900 includes at least one processor circuit, for example, having a processor 903 and a memory 906, both of which are coupled to a local interface 909. The local interface 909 may comprise, for example, a data bus with an accompanying address/control bus or other bus structure as can be appreciated.

Stored in the memory 906 are both data and several components that are executable by the processor 903. In particular, stored in the memory 906 and executable by the processor 903 are the tunnel agent 221, the VPN endpoint 507, the layer-2 tunnel endpoint 512, and the customer premises layer-2 network interface 518, and potentially other components. Also stored in the memory 906 may be a data store and other data. In addition, an operating system may be stored in the memory 906 and executable by the processor 903.

It is understood that there may be other applications that are stored in the memory 906 and are executable by the processor 903 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 906 and are executable by the processor 903. In this respect, the term “executable” means a program file that is in a form that can ultimately be run by the processor 903. Examples of executable programs may be, for example, a compiled program that can be translated into machine code in a format that can be loaded into a random access portion of the memory 906 and run by the processor 903, source code that may be expressed in proper format such as object code that is capable of being loaded into a random access portion of the memory 906 and executed by the processor 903, or source code that may be interpreted by another executable program to generate instructions in a random access portion of the memory 906 to be executed by the processor 903, etc. An executable program may be stored in any portion or component of the memory 906 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 906 is defined herein as including both volatile and nonvolatile memory and data storage components. Volatile components are those that do not retain data values upon loss of power. Nonvolatile components are those that retain data upon a loss of power. Thus, the memory 906 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 903 may represent multiple processors 903 and/or multiple processor cores and the memory 906 may represent multiple memories 906 that operate in parallel processing circuits, respectively. In such a case, the local interface 909 may be an appropriate network that facilitates communication between any two of the multiple processors 903, between any processor 903 and any of the memories 906, or between any two of the memories 906, etc. The local interface 909 may comprise additional systems designed to coordinate this communication, including, for example, performing load balancing. The processor 903 may be of electrical or of some other available construction.

Although the tunnel agent 221, the VPN endpoint 507, the layer-2 tunnel endpoint 512, and the customer premises layer-2 network interface 518, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 8A-8B show the functionality and operation of an implementation of portions of the networked environment 200. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 903 in a computer system or other system. The machine code may be converted from the source code, etc. If embodied in hardware, each block may represent a circuit or a number of interconnected circuits to implement the specified logical function(s).

Although the flowcharts of FIGS. 8A-8B show a specific order of execution, it is understood that the order of execution may differ from that which is depicted. For example, the order of execution of two or more blocks may be scrambled relative to the order shown. Also, two or more blocks shown in succession in FIGS. 8A-8B may be executed concurrently or with partial concurrence. Further, in some embodiments, one or more of the blocks shown in FIGS. 8A-8B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the tunnel agent 221, the VPN endpoint 507, the layer-2 tunnel endpoint 512, and the customer premises layer-2 network interface 518, that comprises software or code can be embodied in any non-transitory computer-readable medium for use by or in connection with an instruction execution system such as, for example, a processor 903 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the tunnel agent 221, the VPN endpoint 507, the layer-2 tunnel endpoint 512, and the customer premises layer-2 network interface 518, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 900, or in multiple computing devices 900.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Embodiments of the present disclosure may be described by one or more of the following clauses:

Clause 1. A system, comprising: a cloud provider network comprising at least one computing device configured to execute an edge application and a virtual private network server for a customer; a customer premises network of the customer that uses private network addresses and is separated from a public network by a gateway; and an edge customer premises equipment (CPE) device on the customer premises network, wherein the edge CPE device is configured to at least: execute a tunneling agent that establishes a layer-3 virtual private network between the customer premises network and the virtual private network server on the cloud provider network; and establish a layer-2 virtual interface for the edge application using a tunnel to encapsulate layer-2 traffic between the customer premises network and the edge application over the layer-3 virtual private network.

Clause 2. The system of clause 1, wherein the edge application is executed in a container or a virtual machine instance on the cloud provider network.

Clause 3. The system of clauses 1 to 2, wherein the at least one computing device is further configured to select a location for executing the edge application based at least in part on at least one of: a proximity of the location to the customer premises network, or a latency between the location and the customer premises network.

Clause 4. The system of clauses 1 to 3, wherein the edge application comprises a plurality of edge applications, and network traffic between the plurality of edge applications on the customer premises network bypasses the tunnel.

Clause 5. The system of clauses 1 to 4, wherein the edge application is configured to at least: generate a graphical user interface; and encode the graphical user interface for rendering by a device on the customer premises network.

Clause 6. The system of clauses 1 to 5, wherein the edge CPE device comprises a hardware radio interface supporting at least one of: Z-WAVE, ZIGBEE, BLUETOOTH low energy, or LORAWAN, and the edge CPE device is configured to expose the hardware radio interface for use by the edge application.

Clause 7. The system of clauses 1 to 6, wherein the edge CPE device comprises a hardware communication port supporting at least one of: RS-232 serial communication or universal serial bus (USB), and the edge CPE device is configured to expose the hardware communication port for use by the edge application.

Clause 8. The system of clauses 1 to 7, wherein the edge application is configured to obtain a network address on the customer premises network via a dynamic host configuration protocol (DHCP) broadcast request sent via the tunnel.

Clause 9. The system of clauses 1 to 8, wherein the tunnel uses Generic Routing Encapsulation Terminal Access Point (GRE-TAP) to encapsulate Ethernet frames on the layer-3 virtual private network.

Clause 10. The system of clauses 1 to 9, wherein the layer-3 virtual private network uses Internet Protocol version 6 (IPv6), and the customer premises network uses Internet Protocol version 4 (IPv4).

Clause 11. A computer-implemented method, comprising: establishing a layer-3 virtual private network between a tunneling agent and a virtual private network server on a cloud provider network, the tunneling agent being executed on an edge customer premises equipment (CPE) device on a customer premises network; and establishing a layer-2 virtual interface for an edge application on the cloud provider network using a tunnel to encapsulate layer-2 traffic between the customer premises network and the edge application over the layer-3 virtual private network.

Clause 12. The computer-implemented method of clause 11, further comprising bridging, by the tunneling agent, the layer-2 traffic from the customer premises network to the layer-2 virtual interface of the edge application.

Clause 13. The computer-implemented method of clauses 11 to 12, further comprising selecting a location for executing the edge application based at least in part on at least one of: a proximity of the location to the customer premises network, or a latency between the location and the customer premises network.

Clause 14. The computer-implemented method of clauses 11 to 13, further comprising obtaining, by the edge application, a network address on the customer premises network via a dynamic host configuration protocol (DHCP) broadcast request sent via the tunnel.

Clause 15. The computer-implemented method of clauses 11 to 14, wherein the tunnel uses Generic Routing Encapsulation Terminal Access Point (GRE-TAP) to encapsulate Ethernet frames on the layer-3 virtual private network.

Clause 16. The computer-implemented method of clauses 11 to 15, wherein the customer premises network uses private network addresses and is separated from a public network by a gateway.

Clause 17. A computer-implemented method, comprising: executing an edge application in a container in a cloud provider network; establishing a layer-2 data connection between the edge application and a customer premises network via a tunnel between a virtual private network server on the cloud provider network and a tunneling agent on the customer premises network; and controlling, by the edge application, an edge customer premises equipment (CPE) device on the customer premises network via the layer-2 data connection.

Clause 18. The computer-implemented method of clause 17, further comprising assigning the edge application a network address on the customer premises network.

Clause 19. The computer-implemented method of clauses 17 to 18, further comprising communicating, by the edge application, with one or more services on a virtual private cloud network in the cloud provider network.

Clause 20. The computer-implemented method of clauses 17 to 19, further comprising encoding, by the edge application, data obtained from the edge CPE device for at least one of: streaming or storage.

Clause 21. A system, comprising: a cloud provider network comprising at least one computing device configured to execute an edge application for a customer; a customer premises network of the customer that uses private network addresses and is separated from a public network by a gateway; and an edge customer premises equipment (CPE) device on the customer premises network, wherein the edge CPE device is configured to at least: establish a layer-3 virtual private network between the cloud provider network and the customer premises network; establish a layer-2 virtual interface for the edge application using a tunnel to encapsulate layer-2 traffic over the layer-3 virtual private network; and map a hardware interface on the edge CPE device so that the hardware interface is accessible by the edge application via the tunnel.

Clause 22. The system of clause 21, wherein the edge application is configured to control one or more Internet of Things (IoT) devices through the hardware interface.

Clause 23. The system of clauses 21 to 22, wherein the edge application is assigned a layer-3 network address on the customer premises network by a dynamic host configuration protocol (DHCP) server on the customer premises network.

Clause 24. The system of clauses 21 to 23, wherein the hardware interface corresponds to a hardware communication port supporting at least one of: RS-232 serial communication or universal serial bus (USB).

Clause 25. The system of clauses 21 to 24, wherein the hardware interface corresponds to a hardware radio interface supporting at least one of: Z-WAVE, ZIGBEE, BLUETOOTH low energy, or LORAWAN.

Clause 26. The system of clause 25, wherein the edge application receives data via the hardware radio interface sent by another device on the premises of the customer and not directly connected to the customer premises network.

Clause 27. A computer-implemented method, comprising: establishing a layer-3 virtual private network between a cloud provider network and a customer premises network of a customer; establishing a layer-2 virtual interface for an edge application executed on the cloud provider network using a tunnel to encapsulate layer-2 traffic over the layer-3 virtual private network; and map a hardware or software interface on an edge device of the customer premises network so that the interface is accessible by the edge application via the tunnel.

Clause 28. The computer-implemented method of clause 27, wherein mapping the interface further comprises mapping a plurality of interfaces on a plurality of edge devices of the customer premises network so that the plurality of interfaces are accessible by the edge application via the tunnel.

Clause 29. The computer-implemented method of clauses 27 to 28, further comprising: sending, by the edge application, first data to a device of the customer via the interface; and receiving, by the edge application, second data from the device of the customer via the interface.

Clause 30. The computer-implemented method of clauses 27 to 29, further comprising executing the edge application in a container in the cloud provider network, the layer-2 virtual interface being a network interface of the container.

Clause 31. The computer-implemented method of clauses 27 to 30, further comprising executing the edge application in a virtual machine instance in the cloud provider network, the layer-2 virtual interface being a network interface of the virtual machine instance.

Clause 32. The computer-implemented method of clauses 27 to 31, further comprising requesting by the edge application a layer-3 network address on the customer premises network from a dynamic host configuration protocol (DHCP) server on the customer premises network.

Clause 33. The computer-implemented method of clauses 27 to 32, wherein the interface corresponds to a hardware communication port supporting at least one of: RS-232 serial communication or universal serial bus (USB).

Clause 34. The computer-implemented method of clauses 27 to 33, wherein the interface corresponds to a hardware radio interface supporting at least one of: Z-WAVE, ZIGBEE, BLUETOOTH low energy, or LORAWAN.

Clause 35. The computer-implemented method of clauses 27 to 34, wherein the interface corresponds to a MATTER interface.

Clause 36. A computer-implemented method, comprising: receiving, by a first device on a customer premises network, data from a second device via an interface of the first device; and forwarding, by the first device, the data via the customer premises network to an edge application executed in a cloud provider network, the edge application having a layer-2 virtual interface on the customer premises network.

Clause 37. The computer-implemented method of clause 36, wherein the edge application has a layer-2 virtual interface on a different customer premises network, and the edge application is configured to forward the data to a third device on the different customer premises network.

Clause 38. The computer-implemented method of clauses 36 to 37, further comprising assigning a layer-3 network address on the customer premises network to a container or a virtual machine instance executing the edge application.

Clause 39. The computer-implemented method of clause 36 to 38, further comprising: receiving, by the first device, subsequent data from the edge application via the customer premises network; and forwarding, by the first device, the subsequent data to the second device via the hardware interface.

Clause 40. The computer-implemented method of clauses 36 to 39, wherein the hardware interface comprises a radio interface to a mesh network.

Clause 41. A system, comprising: a cloud provider network comprising at least one computing device configured to execute an edge application for a customer; a customer premises network of the customer that uses private network addresses and is separated from a public network by a gateway; and an edge customer premises equipment (CPE) device on the customer premises network, wherein the edge CPE device is configured to at least: establish a layer-3 virtual private network between the cloud provider network and the customer premises network; establish a layer-2 virtual interface for the edge application using a tunnel to encapsulate layer-2 traffic over the layer-3 virtual private network; and connect a client device outside of the cloud provider network to the customer premises network via the layer-3 virtual private network.

Clause 42. The system of clause 41, wherein the edge application processes data generated by an Internet of Things (IoT) device on the customer premises network, and the client device accesses the processed data from the edge application via the customer premises network.

Clause 43. The system of clauses 41 to 42, wherein the edge application stores data generated by an Internet of Things (IoT) device on the customer premises network, and the client device accesses the stored data via the customer premises network.

Clause 44. The system of clauses 41 to 43, wherein the client device is assigned a network address on the customer premises network.

Clause 45. The system of clauses 41 to 44, wherein the edge CPE device forwards network traffic between the edge application and the client device.

Clause 46. The system of clauses 41 to 45, wherein the client device is connected to the customer premises network via the layer-3 virtual private network by the client device connecting to a virtual private network server executed in the cloud provider network.

Clause 47. The system of clauses 41 to 46, wherein the client device is connected to the customer premises network via the layer-3 virtual private network by the client device connecting to a virtual private network server executed on the edge CPE device.

Clause 48. A computer-implemented method, comprising: establishing a layer-3 virtual private network between a cloud provider network and a customer premises network of a customer; establishing a layer-2 virtual interface for an edge application executed on the cloud provider network using a tunnel to encapsulate layer-2 traffic over the layer-3 virtual private network; and connecting a client device outside of the cloud provider network to the customer premises network via the layer-3 virtual private network.

Clause 49. The computer-implemented method of clause 48, further comprising assigning a network address on the customer premises network to the client device.

Clause 50. The computer-implemented method of clauses 48 to 49, further comprising forwarding network traffic between the edge application and the client device.

Clause 51. The computer-implemented method of clauses 48 to 50, wherein the client device is connected to the customer premises network via the layer-3 virtual private network by the client device connecting to a virtual private network server executed in the cloud provider network.

Clause 52. The computer-implemented method of clauses 48 to 51, wherein the client device is connected to the customer premises network via the layer-3 virtual private network by the client device connecting to a virtual private network server executed on an edge customer premises equipment (CPE) device.

Clause 53. A computer-implemented method, comprising: assigning a first layer-3 network address on a customer premises network to an edge application executed on a cloud provider network; assigning a second layer-3 network address on the customer premises network to a remote client device connected to the customer premises network via a virtual private network connection; and forwarding data on the customer premises network between the remote client device and the edge application.

Clause 54. The computer-implemented method of clause 53, further comprising: managing, by the edge application, an Internet-of-Things (IoT) device on the customer premises network; and wherein the data relates to the IoT device.

Clause 55. The computer-implemented method of clauses 53 to 54, further comprising executing a virtual private network server on an edge device of the customer premises network to provide the virtual private network connection.

Clause 56. The computer-implemented method of clauses 53 to 55, further comprising executing a virtual private network server in the cloud provider network to provide the virtual private network connection.

Clause 57. The computer-implemented method of clauses 53 to 56, wherein the first layer-3 network address and the second layer-3 network address are assigned dynamically by a dynamic host configuration protocol (DHCP) server on the customer premises network.

Clause 58. The computer-implemented method of clauses 53 to 57, further comprising connecting the edge application with the customer premises network by a tunnel to encapsulate layer-2 traffic over a layer-3 virtual private network between the cloud provider network and the customer premises network.

Clause 59. The computer-implemented method of clauses 53 to 58, further comprising forwarding other data on the customer premises network between the remote client device and an edge device on the customer premises network.

Clause 60. The computer-implemented method of clauses 53 to 59, further comprising connecting the remote client device to an Internet-of-Things (IoT) device via a hardware radio interface in an edge device on the customer premises network.

Clause 61. A system, comprising: a cloud provider network comprising at least one computing device configured to execute a container hosting a large language model (LLM); a customer premises network of a customer that uses private network addresses and is separated from a public network by a gateway; and an edge customer premises equipment (CPE) device on the customer premises network, wherein the edge CPE device is configured to at least: establish a layer-3 virtual private network between the cloud provider network and the customer premises network; establish a layer-2 virtual interface for the container using a tunnel to encapsulate layer-2 traffic over the layer-3 virtual private network; and utilize the LLM to provide a functionality for the edge CPE device.

Clause 62. The system of clause 61, wherein the customer premises network comprises a home network.

Clause 63. The system of clauses 61 to 62, wherein the container is assigned a layer-3 network address on the customer premises network.

Clause 64. The system of clauses 61 to 63, wherein the LLM is trained based at least in part on data obtained from the edge CPE device.

Clause 65. The system of clauses 61 to 64, wherein the functionality comprises natural language processing and voice recognition of audio captured by the edge CPE device.

Clause 66. The system of clauses 61 to 65, wherein the functionality comprises personal automation for the customer via the edge CPE device.

Clause 67. The system of clauses 61 to 66, wherein the functionality comprises optimizing energy usage of Internet-of-Things (IoT) devices of the customer premises network.

Clause 68. The system of clauses 61 to 67, wherein the LLM is specific to the customer.

Clause 69. A computer-implemented method, comprising: establishing a layer-3 virtual private network between a cloud provider network and a customer premises network of a customer; establishing a layer-2 virtual interface for a cloud-based artificial intelligence (AI) engine executed on the cloud provider network using a tunnel to encapsulate layer-2 traffic over the layer-3 virtual private network; and using the cloud-based AI engine to provide a functionality for an edge device on the customer premises network.

Clause 70. The computer-implemented method of clause 69, wherein the edge device is different from another edge device that functions as an endpoint to the tunnel.

Clause 71. The computer-implemented method of clauses 69 to 70, further comprising encrypting data exchanged between the cloud-based AI engine and the edge device.

Clause 72. The computer-implemented method of clauses 69 to 71, further comprising executing the cloud-based AI engine in at least one of: a container or a virtual machine instance.

Clause 73. The computer-implemented method of clauses 69 to 72, further comprising: receiving data generated by the cloud-based AI engine; and sending the data to the edge device via the layer-2 virtual interface.

Clause 74. The computer-implemented method of clauses 69 to 73, further comprising training the cloud-based AI engine based at least in part on data received from the edge device.

Clause 75. The computer-implemented method of clauses 69 to 74, wherein the cloud-based AI engine comprises a large language model (LLM).

Clause 76. The computer-implemented method of clause 69 to 75, wherein the cloud-based AI engine is an instance specific to the customer.

Clause 77. A computer-implemented method, comprising: establishing a layer-3 virtual private network between a cloud provider network and a customer premises network of a customer; establishing a layer-2 virtual interface for a cloud-based artificial intelligence (AI) engine executed on the cloud provider network using a tunnel to encapsulate layer-2 traffic over the layer-3 virtual private network; and training the cloud-based AI engine based at least in part on data received from an edge device on the customer premises network.

Clause 78. The computer-implemented method of clause 77, wherein the cloud-based AI engine is specific to the customer.

Clause 79. The computer-implemented method of clauses 77 to 78, wherein training the cloud-based AI engine further comprises training the cloud-based AI engine to provide a functionality for the edge device.

Clause 80. The computer-implemented method of clauses 77 to 79, wherein the data comprises environmental data captured by the edge device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a cloud provider network comprising at least one computing device configured to execute an edge application for a customer;
a customer premises network of the customer that uses private network addresses and is separated from a public network by a gateway; and
an edge customer premises equipment (CPE) device on the customer premises network, wherein the edge CPE device is configured to at least:
establish a layer-3 virtual private network between the cloud provider network and the customer premises network;
establish a layer-2 virtual interface for the edge application using a tunnel to encapsulate layer-2 traffic over the layer-3 virtual private network; and
map a hardware interface on the edge CPE device so that the hardware interface is accessible by the edge application via the tunnel.

2. The system of claim 1, wherein the edge application is configured to control one or more Internet of Things (IoT) devices through the hardware interface.

3. The system of claim 1, wherein the edge application is assigned a layer-3 network address on the customer premises network by a dynamic host configuration protocol (DHCP) server on the customer premises network.

4. The system of claim 1, wherein the hardware interface corresponds to a hardware communication port supporting at least one of: RS-232 serial communication or universal serial bus (USB).

5. The system of claim 1, wherein the hardware interface corresponds to a hardware radio interface supporting at least one of: Z-WAVE, ZIGBEE, BLUETOOTH low energy, or LORAWAN.

6. The system of claim 5, wherein the edge application receives data via the hardware radio interface sent by another device on the premises of the customer and not directly connected to the customer premises network.

7. A computer-implemented method, comprising:
establishing a layer-3 virtual private network between a cloud provider network and a customer premises network of a customer;
establishing a layer-2 virtual interface for an edge application executed on the cloud provider network using a tunnel to encapsulate layer-2 traffic over the layer-3 virtual private network; and
map a hardware or software interface on an edge device of the customer premises network so that the interface is accessible by the edge application via the tunnel.

8. The computer-implemented method of claim 7, wherein mapping the interface further comprises mapping a plurality of interfaces on a plurality of edge devices of the customer premises network so that the plurality of interfaces are accessible by the edge application via the tunnel.

9. The computer-implemented method of claim 7, further comprising:
sending, by the edge application, first data to a device of the customer via the interface; and
receiving, by the edge application, second data from the device of the customer via the interface.

10. The computer-implemented method of claim 7, further comprising executing the edge application in a container in the cloud provider network, the layer-2 virtual interface being a network interface of the container.

11. The computer-implemented method of claim 7, further comprising executing the edge application in a virtual machine instance in the cloud provider network, the layer-2 virtual interface being a network interface of the virtual machine instance.

12. The computer-implemented method of claim 7, further comprising requesting by the edge application a layer-3 network address on the customer premises network from a dynamic host configuration protocol (DHCP) server on the customer premises network.

13. The computer-implemented method of claim 7, wherein the interface corresponds to a hardware communication port supporting at least one of: RS-232 serial communication or universal serial bus (USB).

14. The computer-implemented method of claim 7, wherein the interface corresponds to a hardware radio interface supporting at least one of: Z-WAVE, ZIGBEE, BLUETOOTH low energy, or LORAWAN.

15. The computer-implemented method of claim 7, wherein the interface corresponds to a MATTER interface.

16. A computer-implemented method, comprising:
receiving, by a first device on a customer premises network, data from a second device via an interface of the first device; and
forwarding, by the first device, the data via the customer premises network to an edge application executed in a cloud provider network, the edge application having a layer-2 virtual interface on the customer premises network.

17. The computer-implemented method of claim 16, wherein the edge application has a layer-2 virtual interface on a different customer premises network, and the edge application is configured to forward the data to a third device on the different customer premises network.

18. The computer-implemented method of claim 16, further comprising assigning a layer-3 network address on the customer premises network to a container or a virtual machine instance executing the edge application.

19. The computer-implemented method of claim 16, further comprising:
receiving, by the first device, subsequent data from the edge application via the customer premises network; and
forwarding, by the first device, the subsequent data to the second device via the hardware interface.

20. The computer-implemented method of claim 16, wherein the hardware interface comprises a radio interface to a mesh network.
